(19) United States
(12) Patent Application Publication
(10) Pub. No.: US 2013/0044723 A1
(43) Pub. Date: Feb. 21, 2013

(54) APPARATUS AND METHOD FOR OBTAINING UPLINK DATA RECEIVING STATE INFORMATION IN USER EQUIPMENT

(71) Applicants: Yingyang Li, Beijing (CN); Chengjun Sun, Beijing (CN); Xiaoqiang Li, Beijing (CN)

(72) Inventors: Yingyang Li, Beijing (CN); Chengjun Sun, Beijing (CN); Xiaoqiang Li, Beijing (CN)

(21) Appl. No.: 13/695,389

(22) PCT Filed: Apr. 26, 2011
(86) PCT No.: PCT/KR2011/003009

§ 371 Date: Oct. 30, 2012

(30) Foreign Application Priority Data
Apr. 30, 2010 (CN) 201010168685.2

(51) Int. Cl. H04W 72/04

(52) U.S. Cl. 370/329

(57) ABSTRACT

The present invention provides a method for obtaining an uplink data receiving state, including: receiving, by User Equipment (UE), an uplink resource allocation control signaling, wherein the uplink resource allocation control signaling includes information for indicating that one Transmission Block (TB) is inactivated; and obtaining information for indicating an uplink data receiving state of the inactivated TB from the uplink resource allocation control signaling or from a Physical Hybrid Automatic Repeat Request (HARQ) Indication Channel (PHICH). According to the present invention, when performing MIMO transmission for the uplink data in the LTE-A system, the UE can perform corresponding HARQ processing for the inactivated TB.

### TECHNICAL FIELD

The present invention relates to communication technologies, and more particularly to an apparatus and a method for obtaining uplink data receiving state information in user equipment.

### BACKGROUND ART

In an Advanced Long Term Evolution (LTE-A) system, data are transmitted by using a Multi-input Multi-output (MIMO) technology to improve the performance of uplinks. Consistent with an LTE system, the physical layer transmission technology of the LTE-A system is still based on Single Carrier Frequency Division Multiple Access (SCFDMA).

Table 1 shows a format of Downlink Control Information (DCI) for scheduling uplink MIMO transmission in the LTE-A system. The DCI includes a pre-encoding information field for indicating the layer number of the uplink MIMO transmission and a Precoding Matrix Index (PMI). Each Transmission Block (TB) includes a New Data Indication (NDI) field and a Modulation Coding Scheme (MCS) field. When a base station schedules two TBs, the NDI field and MCS field of each TB indicate transmission parameters of the TB. When the Base station only schedules one TB, the NDI field and MCS field of the TB in the DCI indicate transmission parameters of the TB; at the same time, the DCI needs to indicate that the other TB is inactivated, and the NDI field and MCS field of the other TB in the DCI do not indicate transmission parameters of the other TB.

Table 1

TABLE 1

| Information field | Bit number |
|---|---|
| Resource allocation | Undetermined |
| MCS (TB0) | 5 |
| MCS (TB1) | 5 |
| NDI (TB0) | 1 |
| NDI (TB1) | 1 |
| TPC | 2 |
| CSI | 3 |
| Frequency hopping indication | 0 or 1 |
| CQI request | 1 |
| Pre-encoding information | 3 or 6 |
| Exchange identity | 0 or 1 |
| SRS activation | 1 |
| CRC (C-RNTI) | 16 |

In the LTE system, there are two methods for indicating User Equipment (UE) to perform uplink data transmission based on Hybrid Automatic Repeat Request (HARQ).

In the first method, response information of an uplink data receiving state is returned through a Physical HARQ Indication Channel (PHICH). If the response information returned through the PHICH is ACK, it is indicated that the uplink data transmission is successful and there are no new data; if the response information returned through the PHICH is NACK, it is indicated that the uplink data transmission is unsuccessful; at this time, if the maximum number of repeat times is not reached, the UE will retransmit the same uplink data in a HARQ cache.

In the second method, response information of the uplink data receiving state is returned by determining whether the value of an NDI field in an uplink resource allocation control signaling changes compared with the value of an NDI field in a previous uplink resource allocation control signaling. If the value of the NDI field in the uplink resource allocation control signaling changes compared with the value of the NDI field in the previous uplink resource allocation control signaling, it is indicated that the base station schedules the UE to transmit a new TB, i.e. it is indicated that the TB corresponding to the NDI field is transmitted successfully; if the value of the NDI field in the uplink resource allocation control signaling does not change compared with the value of the NDI field in the previous uplink resource allocation control signaling, it is indicated that the base station schedules the UE to retransmit the current TB, i.e. it is indicated that the TB corresponding to the NDI field is transmitted unsuccessfully.

Since MIMO transmission is performed for uplink data in the LTE-A system, i.e. two TBs are transmitted in parallel, uplink data receiving states of the two TBs are respectively returned by using the methods in the LTE system when the two TBs are both activated. But, if there is one inactivated TB, at present there is no method for indicating whether the previous data transmission corresponding to the inactivated TB is successful; correspondingly, the UE cannot perform HARQ processing for the inactivated TB.

### DISCLOSURE OF INVENTION

### Solution to Problem

In view of the above, the present invention provides an apparatus and a method for obtaining uplink data receiving state information in UE, so that UE can perform HARQ processing for an inactivated TB when MIMO transmission is performed for the uplink data in an LTE-A system.

A method for obtaining an uplink data receiving state includes: receiving, by UE, an uplink resource allocation control signaling, wherein the uplink resource allocation control signaling includes information for indicating that one TB is inactivated; and obtaining information for indicating an uplink data receiving state of the inactivated TB from the uplink resource allocation control signaling or from a PHICH.

It can be seen from the above technical solution that, in the method of the present invention, when a base station only schedules one TB by using an uplink resource allocation control signaling, the UE can obtain explicit information for indicating an uplink data receiving state of an inactivated TB from the uplink resource allocation control signaling or from a PHICH when MIMO transmission is performed for the uplink data in an LTE-A system, so as to perform HARQ processing for the inactivated TB and avoid improper retransmission of the inactivated TB.

### BRIEF DESCRIPTION OF DRAWINGS

The above and other objects, features and advantages of the present invention will become more apparent from the following detailed description when taken in conjunction with the accompanying drawings in which:

FIG. 1 is a flowchart illustrating a method for obtaining uplink data receiving state information of an inactivated Transmission Block (TB) in a User Equipment (UE) according to an exemplary embodiment of the present invention;

FIG. 2 is a flowchart illustrating a method for obtaining uplink data receiving state information of an inactivated TB in a UE according to a first exemplary embodiment of a first indication mode of the present invention;

FIG. 3 is a flowchart illustrating a method for obtaining uplink data receiving state information of an inactivated TB in a UE according to a second exemplary embodiment of a first indication mode of the present invention;

FIG. 4 is a flowchart illustrating a method for obtaining uplink data receiving state information of an inactivated TB in a UE according to a third exemplary embodiment of a first indication mode of the present invention;

FIG. 5 is a flowchart illustrating a method for obtaining uplink data receiving state information of an inactivated TB in a UE according to an exemplary embodiment of a second indication mode of the present invention;

FIG. 6 is a flowchart illustrating a method for obtaining uplink data receiving state information of an inactivated TB in a UE according to an exemplary embodiment of a third indication mode of the present invention;

FIG. 7 is a flowchart illustrating a method for obtaining uplink data receiving state information of an inactivated TB in a UE according to an exemplary embodiment of a fourth indication mode of the present invention; and

FIG. 8 is a block diagram illustrating an apparatus construction of a UE according to the present invention.

### BEST MODE FOR CARRYING OUT THE INVENTION

In order to make the object, technical solution and merits of the present invention clearer, the present invention will be described hereinafter in detail with reference to the accompany drawings and embodiments.

For uplink data transmission based on MIMO in the LTE-A system, when a base station controls uplink data HARQ transmission by transmitting a new uplink resource allocation control signaling, the base station may schedule UE to transmit data of two TBs in parallel, and may also schedule the UE to only transmit data of one TB. Suppose that the base station schedules uplink data transmission of two TBs at a previous timing location, the base station schedules the UE by using a new uplink resource allocation control signaling to perform uplink data HARQ transmission at a current timing location after the base station receives uplink data. Hereinafter, methods provided by the present invention are described respectively according to the number of TBs activated in the uplink resource allocation control signaling.

When the base station schedules UE to transmit data of two TBs in parallel, the UE determines whether to transmit new data or perform data retransmission according to whether the value of an NDI field of each TB changes compared with the value of an NDI field of the previous uplink resource allocation control signaling. If the value of the NDI field of each TB changes, it is indicated that the uplink data transmission of the TB is successful and the UE may transmit new data through the TB; if the value of the NDI field of each TB does not change, it is indicated that the uplink data transmission of the TB is unsuccessful and the UE performs data retransmission through the TB.

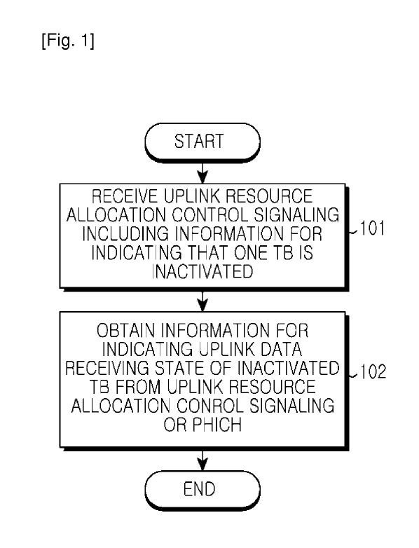

When the base station schedules the UE to only transmit data of one TB, only one TB is activated; a method provided by the present invention is shown in FIG. 1, and includes the following steps.

Step 101: the UE receives an uplink resource allocation control signaling, which includes information for indicating that one TB is inactivated.

Step 102: the UE obtains information for indicating an uplink data receiving state of the inactivated TB from the uplink resource allocation control signaling or from a PHICH.

In addition, the UE may also determine whether to transmit new data or perform data retransmission through the activated TB according to whether the value of the NDI field of the activated TB in the uplink resource allocation control signaling changes.

If the base station schedules the UE to only transmit data of one TB at the current transmission time point and only one TB is activated, the base station carries an indication for indicating that one TB is inactivated in the transmitted uplink resource allocation control signaling, and the UE may learn that one TB is inactivated according to the indication. The present invention does not limit the method for indicating that one TB is inactivated.

For the activated TB, the UE may obtain response information of the uplink data receiving state of the activated TB according to a conventional LTE method. Specifically, the UE obtains the response information of the uplink data receiving state of the activated TB according to whether the value of the NDI field of the activated TB in the uplink resource allocation control signaling changes compared with the value of the NDI field in the previous uplink resource allocation control signaling. If the value of the NDI field of the activated TB in the uplink resource allocation control signaling changes, the base station schedules the UE to transmit new data through the activated TB, i.e. the response information of the uplink data receiving state of the activated TB indicates that uplink data transmission corresponding to the activated TB is successful; if the value of the NDI field of the activated TB in the uplink resource allocation control signaling does not change, the base station schedules the UE to perform data retransmission through the activated TB, i.e. the response information of the uplink data receiving state of the activated TB indicates that that uplink data transmission corresponding to the activated TB is unsuccessful.

For the inactivated TB, the present invention may adopt the following indication modes.

The first indication mode: the uplink data receiving state of the activated TB is indicated in the uplink resource allocation control signaling, and the UE obtains the response information of the uplink data receiving state of the inactivated TB from the uplink resource allocation control signaling.

If the response information of the uplink data receiving state of the inactivated TB indicates that the uplink data transmission corresponding to the inactivated TB is successful, since the response information of the uplink data receiving state of the inactivated TB is transmitted in the uplink resource allocation control signaling, the reliability of the uplink resource allocation control signaling is higher than that of the PHICH, and thus the UE may clear the HARQ cache; or the UE may not clear the HARQ cache for the moment, but clears the HARQ cache and store new data in the HARQ cache after the base station schedules new data on the TB by using the uplink resource allocation control signaling, i.e. clears the HARQ cache and store new data in the HARQ cache when the TB is activated again. Herein, the HARQ cache corresponding to the TB is used to cache uplink data of the TB to be transmitted.

If the response information of the uplink data receiving state of the inactivated TB indicates that the uplink data transmission corresponding to the inactivated TB is unsuccessful, and if the maximum number of HARQ repeat times is not reached, the UE keeps the HARQ cache unchanged, and perform data retransmission when the inactivated TB is activated again; if the maximum number of HARQ repeat times is reached, the UE clears the HARQ cache.

Specifically, the method for indicating the uplink data receiving state of the inactivated TB in the uplink resource allocation control signaling is described hereinafter with reference to several embodiments.

### A First Embodiment

If another information field in the uplink resource allocation control signaling except the NDI field is used to indicate that one TB is inactivated, the NDI field of the inactivated TB becomes one bit of unused information, and thus the NDI field of the inactivated TB may be reused to indicate the response information of the uplink data receiving state of the inactivated TB. A corresponding relation between the value of the NDI field and the response information of the uplink data receiving state may be preconfigured. For example, the value of the NDI field equal to 1 represents that the base station receives the uplink data of the TB successfully, and that the value of the NDI field equal to 0 represents that the base station receives the uplink data of the TB unsuccessfully. Or, the uplink data receiving state is indicated according to whether the value of the NDI field in the uplink resource allocation control signaling changes. For example, if the value of the NDI field changes, it is indicated that the uplink data transmission corresponding to the TB is successfully, but the base station does not schedule the UE to transmit new data through the TB; if the value of the NDI field does not change, it is indicated that the uplink data transmission corresponding to the TB is unsuccessfully, but the base station does not schedule the UE to perform data transmission through the TB

### A Second Embodiment

If it is indicated in the uplink resource allocation control signaling that one TB is inactivated, and there is another redundant information field except the NDI field, the redundant information field may be used to indicate the uplink data receiving state of the current inactivated TB. For example, the value of the redundant information field equal to 1 represents that the base station receives the uplink data of the TB successfully, and the value of the redundant information field equal to 0 represents that the base station receives the uplink data of the TB unsuccessfully.

### A Third Embodiment

If there is no redundant information field when it is indicated in the uplink resource allocation control signaling that one TB is inactivated, multiple combinations of values of an information field for indicating that one TB is inactivated may be used to indicate that the TB is inactivated, and thus, the combinations of values of the information field for indicating that one TB is inactivated may be used to indicate the uplink data receiving state of the inactivated TB. Specifically, one combination of values of the information field for indicating that one TB is inactivated may be used to indicate that the base station receives the uplink data of the TB successfully, and another combination of values of the information field is used to indicate that the base station receives the uplink data of the TB unsuccessfully. For example, it may be defined that two values of an MCS field is used to indicate that one TB is inactivated, and thus the two values of the MCS field may be used to respectively indicate that the uplink data receiving state of the inactivated TB is successful or unsuccessful.

The second indication mode: the PHICH is used to indicate the uplink data receiving state of the inactivated TB, and indicates the uplink data receiving state of the activated TB by combining the uplink resource allocation control signaling.

After the UE receives the PHICH and the uplink resource allocation control signaling, if it is indicated that one TB is inactivated in the uplink resource allocation control signaling, the UE obtains the response information of the receiving state of the inactivated TB form the PHICH corresponding to the inactivated TB; when the PHICH indicates ACK, it is indicated that the base station receives the uplink data of the inactivated TB successfully. But, since the reliability of the PHICH is not high, the UE may not clear the HARQ cache, but clears the HARQ cache after receiving the uplink resource allocation control signaling indicating that the TB is activated and the value of the NDI field of the TB changes. If the PHICH indicates NACK, it is indicated that the base station receives the uplink data of the inactivated TB unsuccessfully; if the maximum number of HARQ repeat times is not reached, the UE keeps the HARQ cache unchanged and perform data retransmission after the inactivated TB is activated again; if the maximum number of HARQ repeat times is reached, the UE clears the HARQ cache.

In addition, the UE obtains the response information of the receiving state of the activated TB according to whether the value of the NDI field of the activated TB in the uplink resource allocation control signaling changes.

The third indication mode: the base station activates the current inactivated TB in an uplink resource allocation control signaling at a subsequent timing location, and indicates the receiving state of the TB according to whether the value of the NDI field in the subsequent uplink resource allocation control signaling changes compared with the value of the NDI field in the previous uplink resource allocation control signaling. The uplink resource allocation control signaling at the subsequent timing location schedules two TBs at the same time, or only schedules one TB and the activated TB is the current inactivated TB. It is indicated that the base station receives uplink data of the TB successfully and schedules new data when the value of the NDI field changes, and the UE clears the HARQ cache and writes the new data into the HARQ cache; if the value of the NDI field does not change, the UE keeps the HARQ cache unchanged, i.e. retransmits the uplink data of the TB.

The fourth indication mode: when performing HARQ transmission for the current activated TB, the base station transmits the uplink data receiving state of the activated TB through a PHICH on a subsequent time sequence, and transmits the uplink data receiving state of the inactivated TB at the same time sequence. For the currently activated TB, if the response information of the uplink data receiving state is ACK, since the reliability of the PHICH is not high, the UE may not clear the HARQ cache at once, but clears the HARQ cache and writes new data into the HARQ cache after receiving the uplink resource allocation control signaling for indicating that the value of the NDI field of the TB changes. If the response information of the uplink data receiving state is NACK and the maximum number of HARQ repeat times is reached, the UE clears the HARQ cache; if the maximum number of HARQ repeat times is reached not, the UE may keep the HARQ cache unchanged and perform data retransmission. For the current inactivated TB, if the response information of the uplink data receiving state is ACK, it is indicated that the uplink data of the TB is received successfully. But, since the reliability of the PHICH is not high, the UE may not clear the HARQ cache at once, but clears the HARQ cache and writes new data into the HARQ cache after receiving the uplink resource allocation control signaling for indicating that the value of the NDI field of the TB changes. If the response information of the uplink data receiving state is NACK and the maximum number of HARQ repeat times is reached, the UE clears the HARQ cache; if the maximum number of HARQ repeat times is not reached, the UE may keep the HARQ cache unchanged and perform data retransmission when the TB is activated again.

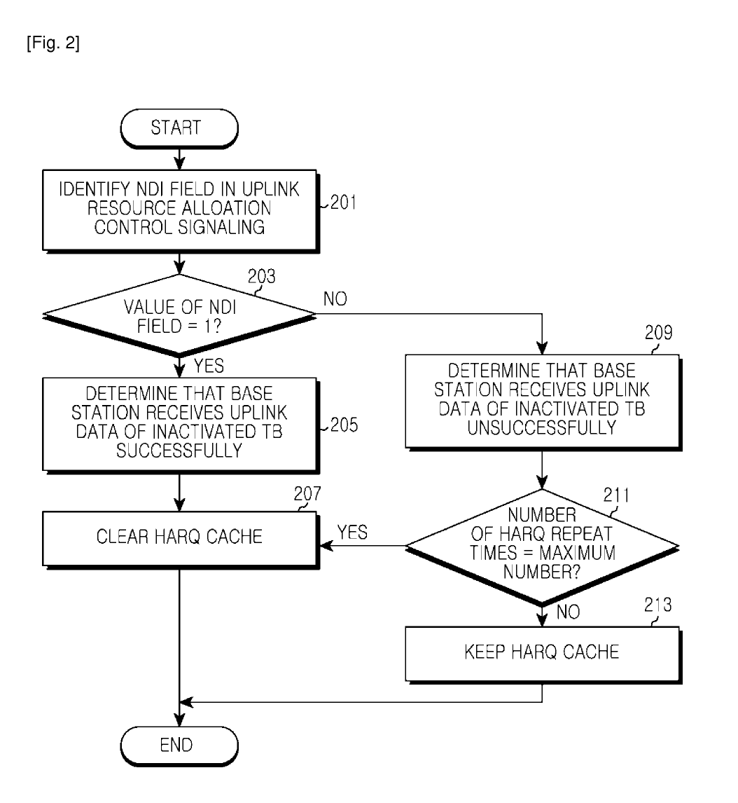

FIG. 2 is a flowchart illustrating a method for obtaining uplink data receiving state information of an inactivated TB in a UE according to a first exemplary embodiment of a first indication mode of the present invention.

Referring to FIG. 2, in step 201, the UE identifies an NDI field in an uplink resource allocation control signaling.

After that, in step 203, the UE determines if a value of the identified NDI field is equal to ‘1’.

When it is determined in step 203 that the value of the identified NDI field is equal to ‘1’, in step 205, the UE determines that a base station receives uplink data of an inactivated TB successfully, and proceeds to step 207.

Next, in step 207, the UE clears a HARQ cache, and writes new data into the HARQ cache and performs new data transmission when the inactivated TB is activated again. In a different way, the UE does not clear the HARQ cache at once, but may clear the HARQ cache, write new data into the HARQ cache, and perform new data transmission when the inactivated TB is activated again.

On the contrary, when it is determined in step 203 that the value of the identified NDI field is equal to ‘0’, in step 209, the UE determines that the base station receives the uplink data of the inactivated TB unsuccessfully, and proceeds to step 211.

After that, in step 211, the UE determines if the maximum number of HARQ repeat times for the inactivated TB is reached.

When it is determined in step 211 that the maximum number of HARQ repeat times for the inactivated TB is reached, the UE proceeds to step 207 and clears the HARQ cache.

On the other hand, when it is determined in step 211 that the maximum number of HARQ repeat times for the inactivated TB is not reached, in step 213, the UE keeps the HARQ cache unchanged, and performs data retransmission when the inactivated TB is activated again.

After that, the UE terminates the algorithm according to the present invention.

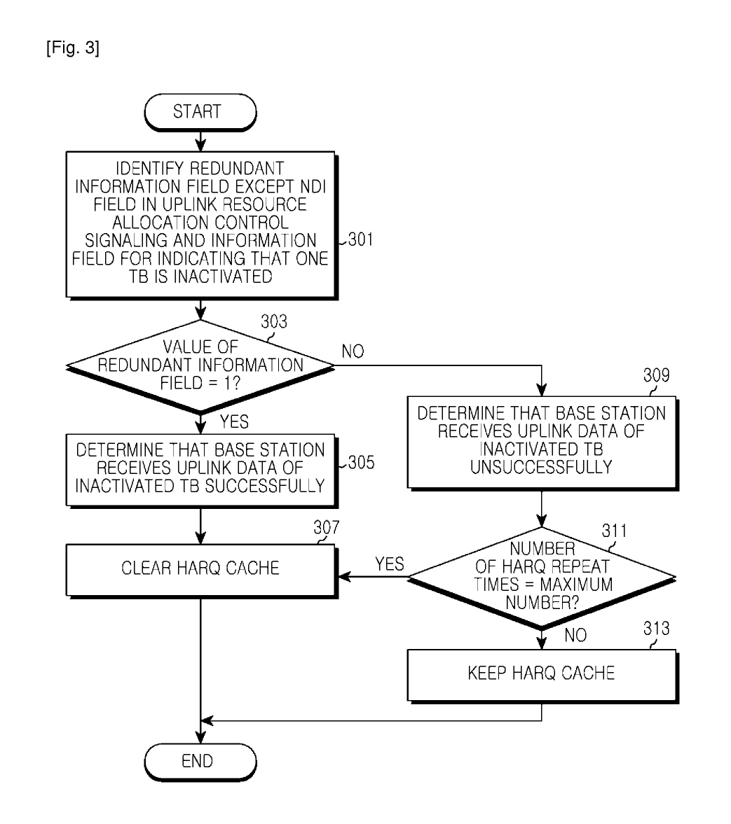

FIG. 3 is a flowchart illustrating a method for obtaining uplink data receiving state information of an inactivated TB in a UE according to a second exemplary embodiment of a first indication mode of the present invention.

Referring to FIG. 3, in step 301, the UE identifies a redundant information field in an uplink resource allocation control signaling, except an NDI field and an information field for indicating that one TB is inactivated.

After that, in step 303, the UE determines if a value of the identified redundant information field is equal to ‘1’.

Next, when it is determined in step 303 that the value of the identified redundant information field is equal to ‘1’, in step 305, the UE determines that a base station receives uplink data of an inactivated TB successfully, and proceeds to step 307.

After that, in step 307, the UE clears a HARQ cache, and writes new data into the HARQ cache and performs new data transmission when the inactivated TB is activated again. In a different way, the UE does not clear a HARQ cache at once, but may clear the HARQ cache, write new data into the HARQ cache, and perform new data transmission when the inactivated TB is activated again.

On the contrary, when it is determined in step 303 that the value of the identified redundant information field is equal to ‘0’, in step 309, the UE determines that the base station receives the uplink data of the inactivated TB unsuccessfully, and proceeds to step 311.

After that, in step 311, the UE determines if the maximum number of HARQ repeat times for the inactivated TB is reached.

When it is determined in step 311 that the maximum number of HARQ repeat times for the inactivated TB is reached, the UE proceeds to step 307 and clears the HARQ cache.

On the contrary, when it is determined in step 311 that the maximum number of HARQ repeat times for the inactivated TB is not reached, in step 313, the UE keeps a HARQ cache unchanged, and performs data retransmission when the inactivated TB is activated again.

Next, the UE terminates the algorithm according to the present invention.

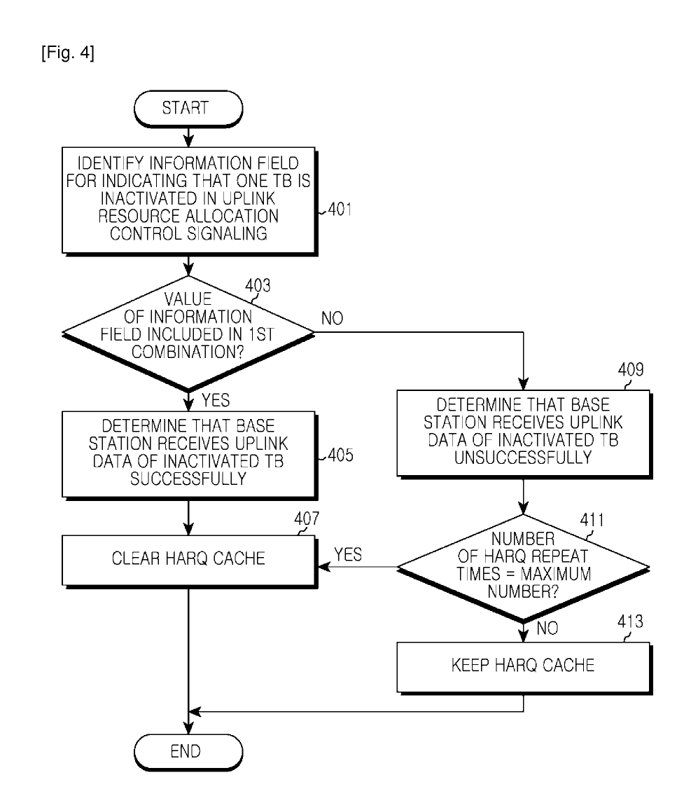

FIG. 4 is a flowchart illustrating a method for obtaining uplink data receiving state information of an inactivated TB in a UE according to a third exemplary embodiment of a first indication mode of the present invention.

Referring to FIG. 4, in step 401, the UE identifies an information field for indicating that one TB is inactivated, in an uplink resource allocation control signaling.

After that, in step 403, the UE determines if a value of the identified information field is included in a 1st combination. Here, the 1st combination, which is one combination of values of information fields for indicating that one TB is inactivated, is used to indicate that a base station receives uplink data of a TB successfully. On the contrary, a 2nd combination, which is another combination of values of information fields for indicating that one TB is inactivated, is used to indicate that a base station receives uplink data of a TB unsuccessfully.

When it is determined in step 403 that the value of the identified information field is included in the 1st combination, in step 405, the UE determines that a base station receives uplink data of the inactivated TB successfully, and proceeds to step 407.

Next, in step 407, the UE clears a HARQ cache, and writes new data into the HARQ cache and performs new data transmission when the inactivated TB is activated again. In a different way, the UE does not clear the HARQ cache at once, but may clear the HARQ cache, write new data into the HARQ cache, and perform new data transmission when the inactivated TB is activated again.

On the contrary, when it is determined in step 403 that the value of the identified information field is included in the 2nd combination, in step 409, the UE determines that the base station receives the uplink data of the inactivated TB unsuccessfully, and proceeds to step 411.

After that, in step 411, the UE determines if the maximum number of HARQ repeat times for the inactivated TB is reached.

When it is determined in step 411 that the maximum number of HARQ repeat times for the inactivated TB is reached, the UE proceeds to step 407 and clears the HARQ cache.

On the contrary, when it is determined in step 411 that the maximum number of HARQ repeat times for the inactivated TB is not reached, in step 413, the UE keeps the HARQ cache unchanged, and performs data retransmission when the inactivated TB is activated again.

After that, the UE terminates the algorithm according to the present invention.

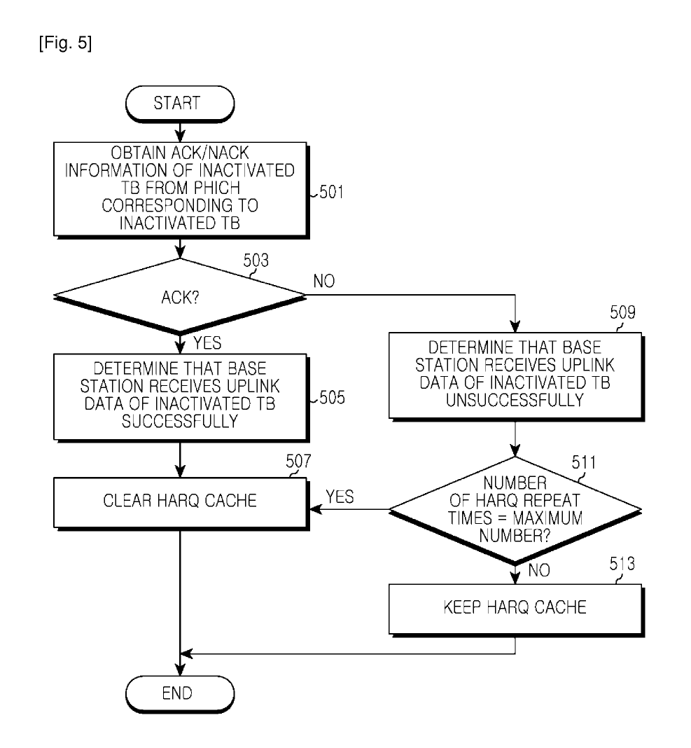

FIG. 5 is a flowchart illustrating a method for obtaining uplink data receiving state information of an inactivated TB in a UE according to an exemplary embodiment of a second indication mode of the present invention.

Referring to FIG. 5, in step 501, the UE obtains ACK or NACK information of an inactivated TB from a Physical Hybrid Automatic Repeat Request (HARQ) Indication Channel (PHICH) corresponding to the inactivated TB.

After that, in step 503, the UE determines if the obtained information is ACK information.

When it is determined in step 503 that the obtained information is ACK information, in step 505, the UE determines that a base station receives uplink data of the inactivated TB successfully, and proceeds to step 507.

Next, in step 507, when the inactivated TB is activated again, the UE clears the HARQ cache, writes new data into the HARQ cache, and performs new data transmission.

On the contrary, when it is determined in step 503 that the obtained information is NACK information, in step 509, the UE determines that the base station receives the uplink data of the inactivated TB unsuccessfully, and proceeds to step 511.

After that, in step 511, the UE determines if the maximum number of HARQ repeat times for the inactivated TB is reached.

When it is determined in step 511 that the maximum number of HARQ repeat times for the inactivated TB is reached, the UE proceeds to step 507 and clears a HARQ cache.

On the contrary, when it is determined in step 511 that the maximum number of HARQ repeat times for the inactivated TB is not reached, in step 513, the UE keeps the HARQ cache unchanged, and performs data retransmission when the inactivated TB is activated again.

Next, the UE terminates the algorithm according to the present invention.

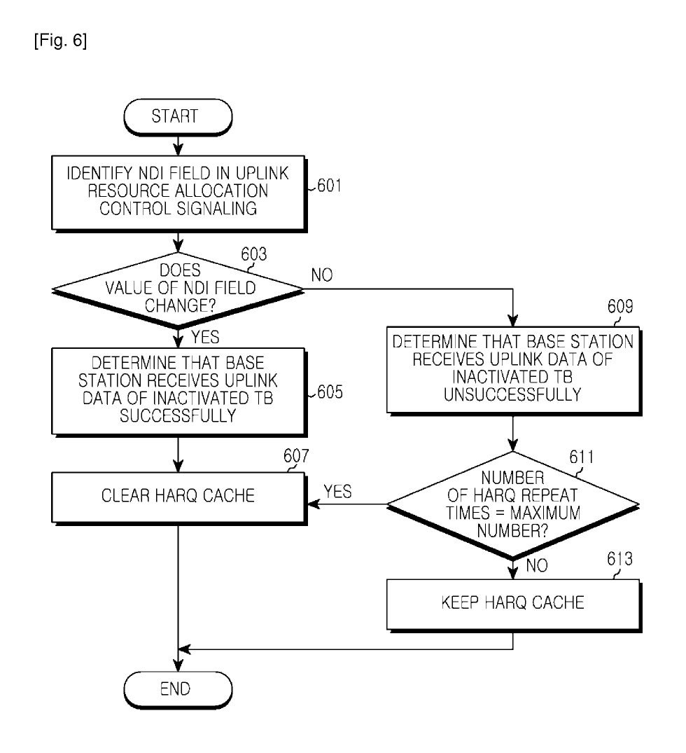

FIG. 6 is a flowchart illustrating a method for obtaining uplink data receiving state information of an inactivated TB in a UE according to an exemplary embodiment of a third indication mode of the present invention.

Referring to FIG. 6, in step 601, the UE identifies an NDI field of an inactivated TB in an uplink resource allocation control signaling.

After that, in step 603, the UE determines if a value of the identified NDI field of the inactivated TB changes compared with a value of an NDI field in a previous uplink resource allocation control signaling.

When it is determined in step 603 that the value of the identified NDI field is changed, in step 605, the UE determines that a base station receives uplink data of the inactivated TB successfully, and proceeds to step 607.

After that, in step 607, the UE clears a HARQ cache, and writes new data into the HARQ cache and performs new data transmission when the inactivated TB is activated again. In a different way, the UE does not clear the HARQ cache at once, but may clear the HARQ cache, write new data into the HARQ cache, and perform new data transmission when the inactivated TB is activated again.

On the contrary, when it is determined in step 603 that the value of the identified NDI field is not changed, in step 609, the UE determines that the base station receives the uplink data of the inactivated TB unsuccessfully, and proceeds to step 611.

After that, in step 611, the UE determines if the maximum number of HARQ repeat times for the inactivated TB is reached.

When it is determined in step 611 that the maximum number of HARQ repeat times for the inactivated TB is reached, the UE proceeds to step 607 and clears the HARQ cache.

On the contrary, when it is determined in step 611 that the maximum number of HARQ repeat times for the inactivated TB is not reached, in step 613, the UE keeps the HARQ cache unchanged, and performs data retransmission when the inactivated TB is activated again.

Next, the UE terminates the algorithm according to the present invention.

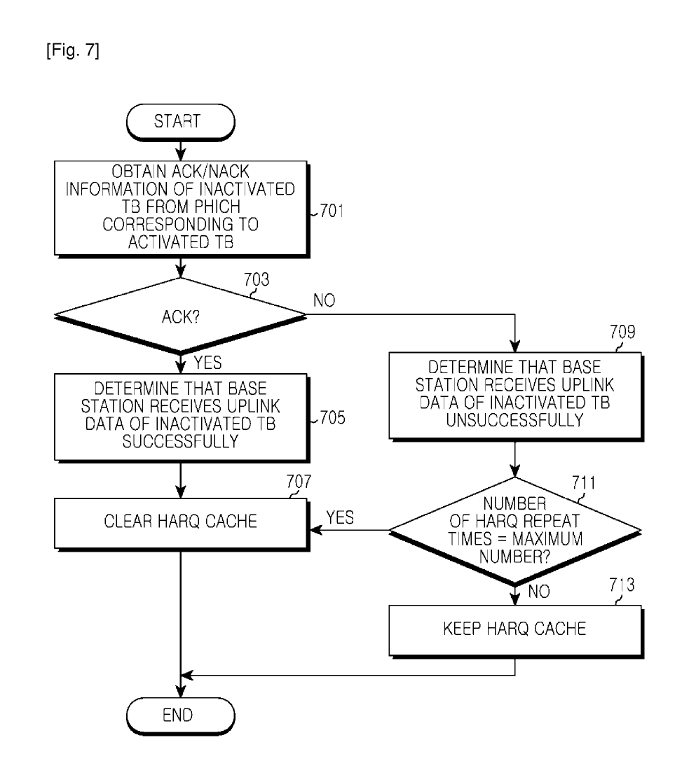

FIG. 7 is a flowchart illustrating a method for obtaining uplink data receiving state information of an inactivated TB in a UE according to an exemplary embodiment of a fourth indication mode of the present invention.

Referring to FIG. 7, in step 701, the UE obtains ACK or NACK information of an inactivated TB from a PHICH corresponding to an activated TB.

After that, in step 703, the UE determines if the obtained information is ACK information.

When it is determined in step 703 that the obtained information is the ACK information, in step 705, the UE determines that a base station receives uplink data of the inactivated TB successfully, and proceeds to step 707.

Next, in step 707, when the inactivated TB is activated again, the UE clears the HARQ cache, writes new data into the HARQ cache, and performs new data transmission.

On the contrary, when it is determined in step 703 that the obtained information is NACK information, in step 709, the UE determines that the base station receives the uplink data of the inactivated TB unsuccessfully, and proceeds to step 711.

Next, in step 711, the UE determines if the maximum number of HARQ repeat times for the inactivated TB is reached.

When it is determined in step 711 that the maximum number of HARQ repeat times for the inactivated TB is reached, the UE proceeds to step 707 and clears the HARQ cache.

On the contrary, when it is determined in step 711 that the maximum number of HARQ repeat times for the inactivated TB is not reached, in step 713, the UE keeps the HARQ cache unchanged, and performs data retransmission when the inactivated TB is activated again.

Next, the UE terminates the algorithm according to the present invention.

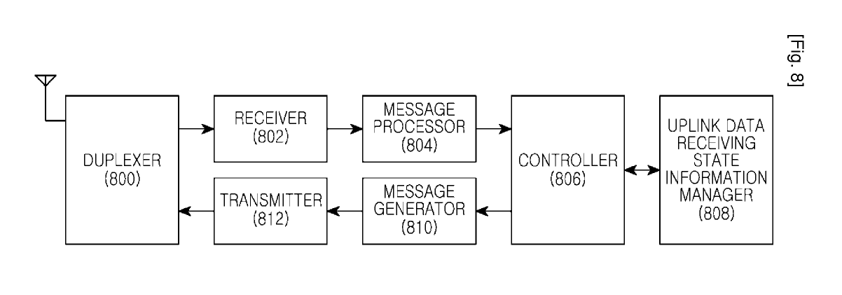

FIG. 8 is a block diagram illustrating an apparatus construction of a UE according to the present invention.

As illustrated, the UE includes a duplexer 800, a receiver 802, a message processor 804, a controller 806, an uplink data receiving state information manager 808, a message generator 810, and a transmitter 812.

Referring to FIG. 8, the duplexer 800 transmits, through an antenna, a transmit signal provided from the transmitter 812 according to a duplexing scheme, and provides a receive signal from the antenna, to the receiver 802.

The receiver 802 restores data from the signal provided from the duplexer 800 and forwards the data to the message processor 804. For example, the receiver 802 includes an RF reception block, a demodulation block, a channel decoding block and the like. At this time, the RF reception block is composed of a filter, an RF preprocessor and the like. The demodulation block is composed of a Fast Fourier Transform (FFT) operator for, when a wireless communication system uses an Orthogonal Frequency Division Multiplexing (OFDM) scheme, extracting data loaded on each subcarrier and the like. The channel decoding block is composed of a demodulator, a deinterleaver, a channel decoder and the like.

The message processor 804 extracts control information from the signal provided from the receiver 802 and provides the control information to the controller 806. For example, the message processor 804 extracts a message related to obtaining of uplink data receiving state information provided from a base station and provides the message to the controller 806. Particularly, the message processor 804 extracts information for indicating that one TB is inactivated from an uplink resource allocation control signaling and provides the extracted information to the uplink data receiving state information manager 808 through the controller 806, and extracts information for indicating the uplink data receiving state of the inactivated TB from the uplink resource allocation control signaling or PHICH and provides the extracted information to the uplink data receiving state information manager 808 through the controller 806.

The controller 806 controls a general operation of the UE. Particularly, the controller 806 controls a general operation for obtaining uplink data receiving state information of an inactivated TB.

The uplink data receiving state information manager 808 obtains, through the message processor 804, information for indicating that one TB is inactivated from an uplink resource allocation control signaling, and obtains information for indicating the uplink data receiving state of the inactivated TB from the uplink resource allocation control signaling or PHICH.

The message generator 810 generates a message to be transmitted to a base station under the control of the controller 806 and provides the message to the transmitter 812. For example, the message generator 810 provides uplink data to the transmitter 812.

The transmitter 812 converts a message or transmit data provided from the message generator 810 into a transmission form through wireless resources and provides the message or transmit data to the duplexer 800. For example, the transmitter 812 includes a channel encoding block, a modulation block, an RF transmission block and the like. At this time, the channel encoding block is composed of a modulator, an interleaver, a channel encoder and the like. The modulation block is composed of an Inverse Fast Fourier Transform (IFFT) operator for, when a wireless communication system uses an OFDM scheme, mapping data to each subcarrier and the like. The RF transmission block is composed of a filter, an RF preprocessor and the like.

In the aforementioned construction, the controller 806 controls a message processor 804, an uplink data receiving state information manager 808, and a message generator 810. That is, the controller 806 can perform functions of the message processor 804, the uplink data receiving state information manager 808, and the message generator 810. These are separately constructed and shown in order to distinguish and describe respective functions in the present invention. Thus, in an actual realization, construction can be such that all the functions are processed in the controller 806, or construction can be such that only part of the functions is processed in the controller 806.

As can be seen from the above description, when the base station only schedules one TB by using the uplink resource allocation control signaling and the MIMO transmission is performed for the uplink data in the LTE-A system, the UE can obtain information for indicating the uplink data receiving state of the inactivated TB from the uplink resource allocation control signaling or from the PHICH by using the method of the present invention, so as to perform corresponding HARQ processing for the inactivated TB and further avoid the improper retransmission of the inactivated TB.

The foregoing is only preferred embodiments of the present invention and is not for use in limiting the invention. Any modification, equivalent substitution, and improvement within the spirit and principle of the invention should be covered in the protection scope of the invention.

1. A method for obtaining an uplink data receiving state information in User Equipment (UE), the method comprising:
receiving, by the UE, an uplink resource allocation control signaling, wherein the uplink resource allocation control signaling includes information for indicating that one Transmission Block (TB) is inactivated; and
obtaining information for indicating an uplink data receiving state of the inactivated TB from one of an uplink resource allocation control signaling and from a Physical Hybrid Automatic Repeat Request (HARQ) Indication. Channel (PHICH).

2. The method of claim 1, wherein obtaining the information for indicating the uplink data receiving state of the inactivated TB from the uplink resource allocation control signaling comprises:
determining, according to a value of a New Data Indication (NDI) field in the uplink resource allocation control signaling, the uplink data receiving state of the inactivated TB which is indicated directly by the value of the NDI field.

3. The method of claim 1, wherein obtaining the information for indicating the uplink data receiving state of the inactivated TB from the PHICH comprises:
obtaining an ACK or a NACK from the PHICH corresponding to the inactivated TB, wherein the ACK indicates that the uplink data of the inactivated TB is received successfully and the NACK indicates that the uplink data of the inactivated TB is received unsuccessfully.

4. The method of claim 1, wherein obtaining the information for indicating the uplink data receiving state of the inactivated TB from the PHICH comprises:
obtaining an ACK or a NACK for the inactivated TB from the PHICH corresponding to an activated TB, wherein the ACK indicates that the uplink data of the inactivated TB is received successfully and the NACK indicates that the uplink data of the inactivated TB is received unsuccessfully.

5. The method of claim 1, further comprising:
obtaining information for indicating an uplink data receiving state of an activated TB according to whether a value of an New Data Indication (NDI) field of the activated TB in the uplink resource allocation control signaling changes compared with a value of an NDI field in a previous uplink resource allocation control signaling.

6. The method of claim 1, wherein:
when the obtained information for indicating an uplink data receiving state of an inactivated TB indicates that the uplink data of the inactivated TB is received successfully, the UE clears a HARQ cache corresponding to the inactivated TB,
the HARQ cache corresponding to the inactivated TB is adapted to cache the uplink data of the inactivated TB to be transmitted.

7. The method of claim 1, wherein obtaining the information for indicating the uplink data receiving state of the inactivated TB from the uplink resource allocation control signaling comprises determining the uplink data receiving state of the inactivated TB, according to whether a value of a New Data Indication (NDI) field of the inactivated TB in the uplink resource allocation control signaling changes compared with a value of an NDI field in a previous uplink resource allocation control signaling.

8. An apparatus configured to obtain an uplink data receiving state information in User Equipment (UE), the apparatus comprising:
a receiver configured to receive an uplink resource allocation control signaling, wherein the uplink resource allocation control signaling comprises information for indicating that one Transmission Block (TB) is inactivated; and
an uplink data receiving state information manager configured to obtain information for indicating one of an uplink data receiving state of the inactivated TB from the uplink resource allocation control signaling and a Physical Hybrid Automatic Repeat Request (HARQ) Indication Channel (PHICH).

9. The apparatus of claim 8, wherein the uplink data receiving state information manager is configured to determine, according to a value of a New Data Indication (NDI) field in the uplink resource allocation control signaling, the uplink data receiving state of the inactivated TB which is indicated directly by the value of the NDI field.

10. The apparatus of claim 8, wherein the uplink data receiving state information manager is configured to obtain an ACK or a NACK from the PHICH corresponding to the inactivated TB, wherein the ACK indicates that uplink data of the inactivated TB is received successfully and the NACK indicates that the uplink data of the inactivated TB is received unsuccessfully.

11. The apparatus of claim 8, wherein the uplink data receiving state information manager is configured to obtain an ACK or a NACK for the inactivated TB from the PHICH corresponding to an activated TB, wherein the ACK indicates that uplink data of the inactivated TB is received successfully and the NACK indicates that uplink data of the inactivated TB is received unsuccessfully.

12. The apparatus of claim 8, wherein the uplink data receiving state information manager is configured to obtain information for indicating an uplink data receiving state of an activated TB according to whether a value of an New Data Indication (NDI) field of the activated TB in the uplink resource allocation control signaling changes compared with a value of an NDI field in a previous uplink resource allocation control signaling.

13. The apparatus of claim 8, wherein:
when the obtained information indicating the uplink data receiving state of the inactivated TB indicates that uplink data of the inactivated TB is received successfully, the uplink data receiving state information manager is configured to clear a HARQ cache corresponding to the inactivated TB,
the HARQ cache corresponding to the inactivated TB is adapted to cache uplink data of an inactivated TB to be transmitted.

14. The apparatus of claim 8, wherein the uplink data receiving state information manager is configured to determine the uplink data receiving state of the inactivated TB according to whether a value of an New Data Indication (NDI) field of the inactivated TB in the uplink resource allocation control signaling changes compared with a value of an NDI field in a previous uplink resource allocation control signaling.

15. The apparatus of claim 8, wherein the uplink data receiving state information manager is configured to determine, according to a value of a redundant information field in the uplink resource allocation control signaling except an New Data Indication (NDI) field and an information field for indicating that one TB is inactivated, the uplink data receiving state of the inactivated TB which is indicated by the value of the redundant information field.

16. The apparatus of claim 8, wherein the uplink data receiving state information manager is configured to determine, according to a combination of values of an information field for indicating that one TB is inactivated in the uplink resource allocation control signaling, the uplink data receiving state of the inactivated TB which is indicated by the combination of values of the information field.

17. The apparatus of claim 8, wherein:
when the obtained information indicating the uplink data receiving state of the inactivated TB indicates that the uplink data of the inactivated TB is received unsuccessfully, the uplink data receiving state information manager keeps a HARQ cache corresponding to the inactivated TB unchanged when the number of repeat times of the inactivated TB does not reach the maximum number of repeat times and the uplink data receiving state information manager clears the HARQ cache corresponding to the inactivated TB when the number of repeat times of the inactivated TB reaches the maximum number of repeat times, and
the HARQ cache corresponding to the inactivated TB is adapted to cache uplink data of an inactivated TB to be transmitted.

18. The method of claim 1, wherein obtaining the information for indicating the uplink data receiving state of the inactivated TB from the uplink resource allocation control signaling comprises:
determining, according to a value of a redundant information field in the uplink resource allocation control signaling except an New Data Indication (NDI) field and an information field for indicating that one TB is inactivated, the uplink data receiving state of the inactivated TB which is indicated by the value of the redundant information field.

19. The method of claim 1, wherein obtaining the information for indicating the uplink data receiving state of the inactivated TB from the uplink resource allocation control signaling comprises:
determining, according to a combination of values of an information field for indicating that one TB is inactivated in the uplink resource allocation control signaling, the uplink data receiving state of the inactivated TB which is indicated by the combination of values of the information field.

20. The method of claim 1, wherein:
when the obtained information for indicating an uplink data receiving state of an inactivated TB indicates that the uplink data of the inactivated TB is received unsuccessfully, the UE keeps the HARQ cache corresponding to the inactivated TB unchanged when the number of repeat times of the inactivated TB does not reach the maximum number of repeat times and the UE clears the HARQ cache corresponding to the inactivated TB when the number of repeat times of the inactivated TB reaches the maximum number of repeat times, and
the HARQ cache corresponding to the inactivated TB is adapted to cache the uplink data of the inactivated TB to be transmitted.
